(19) United States
(12) Patent Application Publication
(10) Pub. No.: US 2026/0138049 A1
(43) Pub. Date: May 21, 2026

(54) APPARATUS FOR RECOVERING SULFUR FROM UNSATURATED SULFUR VAPOR AND USE METHOD THEREFOR

(71) Applicant: FUZHOU UNIVERSITY, Fuzhou (CN)

(72) Inventors: Lilong JIANG, Fuzhou (CN); Minghong Wu, Fuzhou (CN); Yong ZHENG, Fuzhou (CN); Yanning CAO, Fuzhou (CN); Yihong XIAO, Fuzhou (CN)

(73) Assignee: FUZHOU UNIVERSITY, Fuzhou (CN)

(21) Appl. No.: 19/386,339

(22) Filed: Nov. 12, 2025

(30) Foreign Application Priority Data
Nov. 18, 2024 (CN) 2024116448986

(51) Int. Cl. B01D 5/00; C01B 17/02; C01B 17/027

(52) U.S. Cl. CPC B01D 5/0075; B01D 5/0003; B01D 5/0051; B01D 5/009; B01D 5/0093; C01B 17/0232; C01B 17/027; B01D 2257/30

(57) ABSTRACT

An apparatus includes two sulfur recovery units capable of being alternately used, liquid sulfur storage tank and water-cooled sulfur fixing unit, sulfur-free gas outlet is formed in bottom of each sulfur recovery unit, and three-stage heat exchange structure is arranged in each sulfur recovery unit; liquid sulfur outlet is formed in bottom pipe wall of liquid sulfur storage tank and communicated with liquid sulfur storage tank; water-cooled sulfur-solidifying unit is connected with bottom of liquid sulfur storage tank, and liquid sulfur nozzle is arranged on pipeline for connecting top of water-cooled sulfur-solidifying unit with liquid sulfur storage tank. Gas containing unsaturated sulfur vapor is rapidly cooled by three-stage dry cooling, and sulfur vapor in gas can be effectively condensed in sulfur recovery apparatus. Condensed sulfur solid is re-melted by reheating, and high-purity liquid sulfur can be recovered, while preventing granular sulfur from clogging pipeline.

### TECHNICAL FIELD

The present invention relates to the technical field of atmosphere purification and environmental protection, and in particular to an apparatus for recovering sulfur from unsaturated sulfur vapor and a use method therefor.

### BACKGROUND

Among the technologies for desulfurization of blast furnace gas in China, converting sulfur pollutants in blast furnace gas into high-purity sulfur is an excellent technology for resource utilization of sulfur-containing waste gas. For example, the patents CN111748383B and CN111732975A, etc., which have been applied for, disclose their desulfurization process. The general practice is to first convert COS in the gas into H₂S, and then partially oxidize H₂S into sulfur for recovery. However, in the process of sulfur recovery, there is still a small amount of unsaturated sulfur vapor or particles in the tail gas that cannot be effectively recovered. The reason is as follows: on the one hand, when the temperature of the tail gas is lower than 70° C., the sulfur particles in the gas will slowly block the pipeline, causing the internal pressure of the device to be too high, which may cause a safety accident; when the tail gas temperature is higher than 150° C., there is still a large amount of unsaturated sulfur vapor (greater than 2000 ppm) in the gas that has not been effectively recovered, resulting in excessive sulfur content in tail gas emissions.

### SUMMARY OF THE INVENTION

The present invention aims to solve the deficiencies of the prior art and provides an apparatus for recovering sulfur from unsaturated sulfur vapor and a method for using the apparatus. The gas containing unsaturated sulfur vapor is rapidly cooled by three-stage dry cooling, and the sulfur vapor in the gas can be effectively condensed in the sulfur recovery apparatus, thereby achieving effective desulfurization of the gas. The condensed sulfur solid is re-melted by reheating, and high-purity liquid sulfur can be recovered, while preventing the granular sulfur from clogging the pipeline.

The present invention adopts the following technical solution:

Provided is an apparatus for recovering sulfur from unsaturated sulfur vapor, the device comprises at least two sulfur recovery units arranged in parallel and can be used alternately, a liquid sulfur storage tank and a water-cooled sulfur-solidifying unit arranged below the sulfur recovery units, wherein the top of each sulfur recovery unit is connected and then converged upwards to form a sulfur-containing gas inlet, the bottom of each sulfur recovery unit is constricted and then extended laterally to form a sulfur-free gas outlet, and a gate valve is provided at each sulfur-free gas outlet, the sulfur recovery unit is internally provided with a heat exchange structure for condensing sulfur vapor through dry rapid cooling treatment; a liquid sulfur outlet is provided on the bottom pipe wall of each sulfur recovery unit, and each liquid sulfur outlet is connected to the liquid sulfur storage tank for storing liquefied sulfur; the water-cooled sulfur-solidifying unit is connected to the bottom of the liquid sulfur storage tank, and a liquid sulfur nozzle is provided on the pipeline connected to the liquid sulfur storage tank at the top of the water-cooled sulfur-solidifying unit, for rapid cooling and solidifying liquid sulfur into spherical sulfur particles.

Preferably, the sulfur recovery unit comprises two identical structures, namely a first sulfur recovery unit and a second sulfur recovery unit, which are alternately used as a cold and a hot unit for cooling and heating each other, each sulfur recovery unit is provided with a three-stage heat exchanger and three guide plates, and the three guide plates divide the sulfur recovery unit into four chambers from top to bottom, and each chamber is provided with a pressure gauge and a thermometer. During cooling, the sulfur vapor in the gas is condensed into solid sulfur and enriched on the surface of the heat exchanger; during heating, the solid sulfur enriched on the surface of the heat exchanger is liquefied into liquid sulfur, thereby collecting high-purity liquid sulfur into the liquid sulfur storage tank.

Preferably, the three-stage heat exchanger comprises a first-stage heat exchanger, a second-stage heat exchanger and a third-stage heat exchanger from bottom to top, and cooling water or steam enters from the first-stage heat exchanger and passes through the second-stage heat exchanger and the third-stage heat exchanger in sequence, thereby achieving the dual effects of cooling and heating.

Preferably, each sulfur recovery unit is provided with an electrically heated insulation layer at a bottom of each sulfur recovery unit, and a back-blowing microporous filter is installed at each sulfur-free gas outlet.

The sulfur recovery unit is provided with a blower back-blowing device at an outlet of the sulfur recovery unit for purging sulfur-free gas after sulfur melting is completed, thereby achieving the cooling of the sulfur recovery unit and sulfur vapor purging. When sulfur melting is completed, sulfur-free gas can be purged from the sulfur recovery unit on the cold side to the sulfur recovery unit on the hot side, which can cool the sulfur recovery unit on the hot side on the one hand, and purge sulfur vapor remaining in the sulfur recovery unit on the other hand.

The liquid sulfur nozzle is located below the liquid sulfur storage tank and is connected by an inverted U-shaped pipe, and the liquid sulfur is sprayed out by using the siphon principle to generate pressure; a linkage trigger switch is provided above the liquid sulfur nozzle and is linked to an agitator at the bottom of the water-cooled sulfur-solidifying unit, and the agitator is automatically turned on when liquid sulfur passes through; a constant temperature heating layer is provided on the outside of the liquid sulfur storage tank and on the outside of the pipe connecting the liquid sulfur storage tank to the liquid sulfur nozzle, and a pressure gauge is installed inside and above the liquid sulfur storage tank to monitor the flow of sulfur to the liquid sulfur storage tank.

Preferably, the top of the inverted U-shaped pipe is lower than the top of the liquid sulfur storage tank and has a height difference of 1.5 to 2.5 meters with the bottom of the liquid sulfur storage tank.

The temperature of the constant temperature heating layer is controlled at 130° C. to 135° C. to ensure that the sulfur in the pipeline is a liquid with good fluidity.

A first pressure gauge, a second pressure gauge, a third pressure gauge and a fourth pressure gauge are respectively arranged in four chambers from top to bottom in each of the sulfur recovery units; a first thermometer, a second thermometer, a third thermometer and a fourth thermometer are respectively arranged in four chambers from top to bottom in each of the sulfur recovery units; and a fifth pressure gauge is installed inside the liquid sulfur storage tank, at the upper part of the liquid sulfur storage tank.

A first gate valve is provided at the sulfur-free gas outlet on the first sulfur recovery unit, and a second gate valve is provided at the sulfur-free gas outlet on the second sulfur recovery unit.

The inner side of the water-cooled sulfur-solidifying unit is equipped with a water-temperature thermometer, the upper side is equipped with a water inlet for replenishing chilled water, and the lower side is equipped with a water outlet. When the water temperature of the water-cooled sulfur-solidifying unit exceeds 40° C., the water inlet is opened, cold water is replenished and injected, and warm water flows out from the water outlet; when the water temperature drops to 20° C., water replenishment is stopped.

Provided is a method of using an apparatus for recovering sulfur from unsaturated sulfur vapor, wherein the method comprises the following steps:
S1, opening a first gate valve and closing a second gate valve, so that the high-temperature gas containing unsaturated sulfur vapor is introduced into a three-stage heat exchanger in a first sulfur recovery unit through a sulfur gas inlet for dry rapid cooling treatment, so that the sulfur vapor in the gas is condensed in the first sulfur recovery unit, and the sulfur-free gas is discharged from the sulfur-free gas outlet on the first sulfur recovery unit;
S2, when the amount of solid sulfur collected in the first sulfur recovery unit reaches a set amount, closing the first gate valve and opening the second gate valve, switching to the second sulfur recovery unit for collection; the first sulfur recovery unit performing heat treatment to melt the sulfur, and collecting the liquid sulfur into the liquid sulfur storage tank;
S3, when the liquid sulfur level in the liquid sulfur storage tank reaches a set height, the liquid sulfur automatically flowing into a water-cooled sulfur-solidifying unit through a liquid sulfur nozzle, and after rapid cooling treatment by cold water, directly obtaining spherical sulfur particles with a certain size.

The temperature of the high-temperature gas containing unsaturated sulfur vapor in step S1 is in a range from 150° C. to 250° C.

In the three-stage heat exchanger in step S1, cooling water or steam enters a second-stage heat exchanger from a first-stage heat exchanger and finally comes out from a third-stage heat exchanger, thereby achieving the dual effects of cooling and heating; when the heat exchanger is used as a cooling device, cold water is introduced; when the heat exchanger is used as a heater, high-temperature steam is introduced.

The first sulfur recovery unit is activated in step S2 when heat-treated molten sulfur is used as molten sulfur, and the insulation temperature is in a range from 130° C. to 135° C.

In step S3, when the pressure of the fifth pressure gauge in the liquid sulfur storage tank is greater than the pressure value of the fourth pressure gauge in the first sulfur recovery unit, it indicates that liquid sulfur in the first sulfur recovery unit flows into the liquid sulfur storage tank; when the pressure of the fifth pressure gauge is equal to the pressure value of the fourth pressure gauge, it indicates that no liquid sulfur flows into the liquid sulfur storage tank.

The liquid sulfur in the liquid sulfur storage tank enters the water-cooled sulfur-solidifying unit intermittently through the liquid sulfur nozzle. Only when the height of the liquid sulfur in the liquid sulfur storage tank is higher than the height of the inverted U-shaped pipe, the liquid sulfur will enter the water-cooled sulfur-solidifying unit through the liquid sulfur nozzle. When the liquid sulfur in the liquid sulfur storage tank is exhausted and there is no liquid sulfur in the inverted U-shaped pipe, no liquid sulfur will flow out of the liquid sulfur nozzle. At this time, the liquid sulfur storage tank is in a state of collecting liquid sulfur. Only when the height of the liquid sulfur in the liquid sulfur storage tank is higher than the height of the inverted U-shaped pipe again, the liquid sulfur nozzle will flow out liquid sulfur again, and the cycle will continue.

Each time the liquid sulfur storage tank is emptied of liquid sulfur, the solid spherical sulfur in the water-cooled sulfur-solidifying unit can be discharged from the bottom, and the particle size of the solid sulfur can be adjusted by the aperture of the liquid sulfur nozzle.

The technical solution of the present invention has the following advantages:
A. The method of collecting sulfur according to the present invention, by three-stage heat exchange dry cooling and segmented condensation, can greatly improve the desulfurization efficiency of blast furnace gas and sulfur yield. The principle is as follows: through the third-stage cooling, the gas is first cooled to between 80° C. and 120° C.; then through the second-stage cooling, the gas is further cooled to between 40° C. and 80° C.; finally, through the first-stage cooling, the gas is cooled to between 20° C. and 40° C., which can reduce the sulfur concentration in the gas to below 2 ppm. Then, the condensed sulfur is melted into liquid and discharged by heating the molten sulfur, so as to achieve the purpose of recovering high-purity liquid sulfur and prevent the granular sulfur from blocking the pipeline.
B. The present invention adopts a method of collecting sulfur by alternating between cold and hot to achieve continuous removal of sulfur-containing gas.
C. The present invention uses a shower-type liquid sulfur nozzle to discharge liquid sulfur to cold water for rapid cooling and solidification treatment, and can directly obtain 2-4 mm spherical sulfur solids, and the purity of the sulfur is greater than 99.5%.

### BRIEF DESCRIPTION OF THE DRAWINGS

To more clearly illustrate the specific embodiments of the present invention, the accompanying drawings used in the specific embodiments will be briefly introduced below. Obviously, the drawings described below are some embodiments of the present invention. For those skilled in the art, other drawings can be obtained from these drawings without creative effort.

FIG. 1 is a schematic diagram of the overall structure of the apparatus for recovering sulfur from unsaturated sulfur vapor according to the present invention.

The reference signs in the drawings are labeled as follows:
1—sulfur recovery unit, 1A—first sulfur recovery unit, 1B—second sulfur recovery unit, 11—sulfur-containing gas inlet, 12—sulfur-free gas outlet, 121—first gate valve, 122—second gate valve, 13—liquid sulfur outlet, 14—heat exchanger, 141—first-stage heat exchanger, 142—second-stage heat exchanger, 143—third-stage heat exchanger, 15—guide plate, 16—electrically heated insulation layer, 17—microporous filter, 2—liquid sulfur storage tank, 21—constant temperature heating layer, 3—water-cooled sulfur-solidifying unit, 31—liquid sulfur nozzle, 32—trigger switch, 33—agitator, 34—water temperature thermometer, 35—water inlet, 36—water outlet, 4—blower back-blowing device;
P1—first pressure gauge, P2—second pressure gauge, P3—third pressure gauge, P4—fourth pressure gauge, P5—fifth pressure gauge;
T1—first thermometer, T2—second thermometer, T3—third thermometer, T4—fourth thermometer;
K1—first block valve, K2—second block valve, K3—third block valve, K4—fourth block valve, K5—fifth block valve, K6—sixth block valve, K7—seventh block valve, K8—eighth block valve.

### DETAILED DESCRIPTION

The technical solution of the present invention will now be clearly and completely described with reference to the accompanying drawings. Obviously, the described embodiments are only some examples of the present invention, and not all embodiments. Based on the examples of the present invention, all other examples obtained by those skilled in the art without creative effort are within the scope of protection of the present invention.

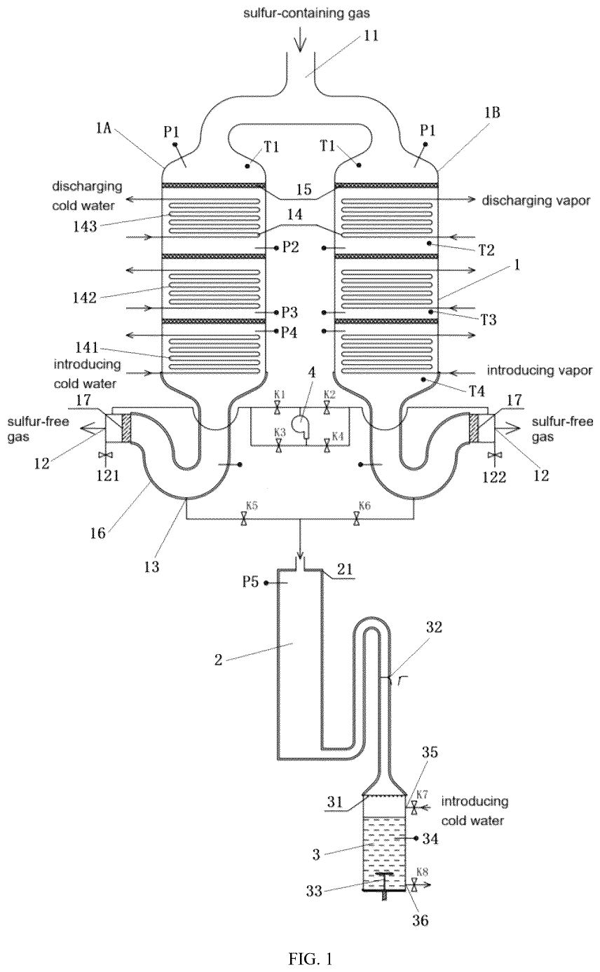

As shown in FIG. 1, the present invention provides an apparatus for recovering sulfur from unsaturated sulfur vapor, the apparatus comprises at least two sulfur recovery units 1 arranged in parallel and can be used alternately, a liquid sulfur storage tank 2 and a water-cooled sulfur-solidifying unit 3 arranged below the sulfur recovery units 1, wherein the top of each sulfur recovery unit 1 is connected and then converged upwards to form a sulfur-containing gas inlet 11, the bottom of each sulfur recovery unit 1 is constricted and then extended laterally to form a sulfur-free gas outlet 12, and a gate valve is provided at each sulfur-free gas outlet 12. The sulfur recovery unit 1 is internally provided with a heat exchange structure for condensing sulfur vapor through dry rapid cooling treatment; a liquid sulfur outlet 13 is provided on the bottom pipe wall of each sulfur recovery unit 1, and each liquid sulfur outlet 13 is connected to the liquid sulfur storage tank 2 for storing liquefied sulfur. The water-cooled sulfur-solidifying unit 3 is connected to the bottom of the liquid sulfur storage tank 2, and a liquid sulfur nozzle 31 is provided on the pipeline connected to the liquid sulfur storage tank 2 at the top of the water-cooled sulfur-solidifying unit 3, for rapid cooling and solidifying liquid sulfur into spherical sulfur particles.

Further, the sulfur recovery unit 1 comprises two identical structures, namely a first sulfur recovery unit 1A and a second sulfur recovery unit 1B, which are alternately used as a cold and a hot unit for cooling and heating each other, each sulfur recovery unit 1 is provided with a three-stage heat exchanger 14 and three guide plates 15, and the three guide plates 15 divide the sulfur recovery unit 1 into four chambers from top to bottom, and each chamber is provided with a pressure gauge and a thermometer. During cooling, the sulfur vapor in the gas is condensed into solid sulfur and enriched on the surface of the heat exchanger 15; during heating, the solid sulfur enriched on the surface of the heat exchanger 15 is liquefied into liquid sulfur, thereby collecting high-purity liquid sulfur into the liquid sulfur storage tank 2.

The three-stage heat exchanger 14 comprises a first-stage heat exchanger 141, a second-stage heat exchanger 142 and a third-stage heat exchanger 143 from bottom to top, and cooling water or steam enters from the first-stage heat exchanger 141 and passes through the second-stage heat exchanger 142 and the third-stage heat exchanger 143 in sequence, thereby achieving the dual effects of cooling and heating. The method of collecting sulfur according to the present invention, by three-stage heat exchange dry cooling and segmented condensation, can greatly improve the desulfurization efficiency of blast furnace gas and sulfur yield. The principle is as follows: through the third-stage cooling, the gas is first cooled to between 80° C. and 120° C.; then through the second-stage cooling, the gas is further cooled to between 40° C. and 80° C.; finally, through the first-stage cooling, the gas is cooled to between 20° C. and 40° C., which can reduce the sulfur concentration in the gas to below 2 ppm. Then, the condensed sulfur is melted into liquid and discharged by heating the molten sulfur, so as to achieve the purpose of recovering high-purity liquid sulfur and prevent the granular sulfur from blocking the pipeline.

Each sulfur recovery unit 1 is provided with an electrically heated insulation layer 16 at a bottom of each sulfur recovery unit 1, and a back-blowing microporous filter 17 is installed at each sulfur-free gas outlet 12. The sulfur recovery unit 1 is provided with a blower back-blowing device 4 at an outlet of the sulfur recovery unit 1 for purging sulfur-free gas after sulfur melting is completed, thereby achieving the cooling of the sulfur recovery unit 1 and sulfur vapor purging. When sulfur melting is completed, sulfur-free gas can be purged from the sulfur recovery unit on the cold side to the sulfur recovery unit on the hot side, which can cool the sulfur recovery unit on the hot side on the one hand, and purge sulfur vapor remaining in the sulfur recovery unit on the other hand.

The liquid sulfur nozzle 31 is located below the liquid sulfur storage tank 2 and is connected by an inverted U-shaped pipe, and the liquid sulfur is sprayed out by using the siphon principle to generate pressure; a linkage trigger switch 32 is provided above the liquid sulfur nozzle 31 and is linked to an agitator 33 at the bottom of the water-cooled sulfur-solidifying unit 3, and the agitator 33 is automatically turned on when liquid sulfur passes through; a constant temperature heating layer 21 is provided on the outside of the liquid sulfur storage tank 2 and on the outside of the pipe connecting the liquid sulfur storage tank 2 to the liquid sulfur nozzle 31, and a pressure gauge is installed inside and above the liquid sulfur storage tank 2 to monitor the flow of sulfur to the liquid sulfur storage tank 2. The top of the inverted U-shaped pipe is lower than the top of the liquid sulfur storage tank 2 and has a height difference of 1.5 to 2.5 meters with the bottom of the liquid sulfur storage tank 2. The temperature of the constant temperature heating layer 21 is controlled at 130° C. to 135° C. to ensure that the sulfur in the pipeline is a liquid with good fluidity.

A first pressure gauge P1, a second pressure gauge P2, a third pressure gauge P3 and a fourth pressure gauge P4 are respectively arranged in four chambers from top to bottom in each of the sulfur recovery units 1; a first thermometer T1, a second thermometer T2, a third thermometer T3 and a fourth thermometer T4 are respectively arranged in four chambers from top to bottom in each of the sulfur recovery units 1; and a fifth pressure gauge P5 is installed inside the liquid sulfur storage tank 2, at the upper part of the liquid sulfur storage tank. A first gate valve 121 is provided at the sulfur-free gas outlet 12 on the first sulfur recovery unit 1A, and a second gate valve 122 is provided at the sulfur-free gas outlet 12 on the second sulfur recovery unit 1B.

The inner side of the water-cooled sulfur-solidifying unit 3 is equipped with a water-temperature thermometer 34, the upper side is equipped with a water inlet 35 for replenishing chilled water, and the lower side is equipped with a water outlet 36. When the water temperature of the water-cooled sulfur-solidifying unit 3 exceeds 40° C., the water inlet 35 is opened, cold water is replenished and injected, and warm water flows out from the water outlet 36; when the water temperature drops to 20° C., water replenishment is stopped.

The present invention further provides a method of using an apparatus for recovering sulfur from unsaturated sulfur vapor, wherein the method comprises the following steps:
S1, opening a first gate valve 121 and closing a second gate valve 122, so that the high-temperature gas containing unsaturated sulfur vapor is introduced into a three-stage heat exchanger 14 in a first sulfur recovery unit 1A through a sulfur gas inlet 11 for dry rapid cooling treatment, so that the sulfur vapor in the gas is condensed in the first sulfur recovery unit 1A, and the sulfur-free gas is discharged from the sulfur-free gas outlet 12 on the first sulfur recovery unit 1A;
S2, when the amount of solid sulfur collected in the first sulfur recovery unit 1A reaches a set amount, closing the first gate valve 121 and opening the second gate valve 122, switching to the second sulfur recovery unit 1B for collection; the first sulfur recovery unit 1A performing heat treatment to melt the sulfur, and collecting the liquid sulfur into the liquid sulfur storage tank 2;
S3, when the liquid sulfur level in the liquid sulfur storage tank 2 reaches a set height, the liquid sulfur automatically flowing into a water-cooled sulfur-solidifying unit 3 through a liquid sulfur nozzle 31, and after rapid cooling treatment by cold water, directly obtaining spherical sulfur particles with a certain size.

The temperature of the high-temperature gas containing unsaturated sulfur vapor in step S1 is in a range from 150° C. to 250° C. In the three-stage heat exchanger 14 in step S1, cooling water or steam enters a second-stage heat exchanger 142 from a first-stage heat exchanger 141 and finally comes out from a third-stage heat exchanger 143, thereby achieving the dual effects of cooling and heating; when the heat exchanger is used as a cooling device, cold water is introduced; when the heat exchanger is used as a heater, high-temperature steam is introduced.

The first sulfur recovery unit 1A is activated in step S2 when heat-treated molten sulfur is used as molten sulfur, and the insulation temperature is in a range from 130° C. to 135° C.

In step S3, when the pressure of the fifth pressure gauge P5 in the liquid sulfur storage tank 2 is greater than the pressure value of the fourth pressure gauge P4 in the first sulfur recovery unit 1A, it indicates that liquid sulfur in the first sulfur recovery unit 1A flows into the liquid sulfur storage tank 2; when the pressure of the fifth pressure gauge P5 is equal to the pressure value of the fourth pressure gauge P4, it indicates that no liquid sulfur flows into the liquid sulfur storage tank 2.

The liquid sulfur in the liquid sulfur storage tank 2 enters the water-cooled sulfur-solidifying unit 3 intermittently through the liquid sulfur nozzle 31. Only when the height of the liquid sulfur in the liquid sulfur storage tank 2 is higher than the height of the inverted U-shaped pipe, the liquid sulfur will enter the water-cooled sulfur-solidifying unit through the liquid sulfur nozzle 31. When the liquid sulfur in the liquid sulfur storage tank 2 is exhausted and there is no liquid sulfur in the inverted U-shaped pipe, no liquid sulfur will flow out of the liquid sulfur nozzle 31. At this time, the liquid sulfur storage tank 2 is in a state of collecting liquid sulfur. Only when the height of the liquid sulfur in the liquid sulfur storage tank 2 is higher than the height of the inverted U-shaped pipe again, the liquid sulfur nozzle 31 will flow out liquid sulfur again, and the cycle will continue.

Each time the liquid sulfur storage tank 2 is emptied of liquid sulfur, the solid spherical sulfur in the water-cooled sulfur-solidifying unit 3 can be discharged from the bottom, and the particle size of the solid sulfur can be adjusted by the aperture of the liquid sulfur nozzle 31.

The following are three specific application examples.

### Example 1

1t/h of 25° C. cooling water is introduced into the heat exchanger of the first sulfur recovery structure 1A, the gate valve 121 is opened, the gate valve 122 is closed, and 2000 Nm³/h, 180° C. gas containing unsaturated sulfur vapor is introduced. After the high-temperature gas is cooled by heat exchange, the temperature drops rapidly: the second thermometer T2 is between 110° C. and 120° C.; the third thermometer T3 is between 50° C. and 60° C.; the fourth thermometer T4 is between 25° C. and 30° C.; after the gas is stably introduced for 46 hours, when the first pressure gauge P1 in the first sulfur recovery structure 1A reaches 10.5 Kpa, the gate valve 122 is slowly opened, the gate valve 121 is closed at the same time, and the second sulfur recovery structure 1B is switched for collection; the sulfur content in the gas after desulfurization treatment is less than 2 ppm.

The first sulfur recovery structure 1A is subjected to heat treatment to melt sulfur: the cooling water in the first sulfur recovery structure 1A is turned off, and 150° C. water vapor is introduced to heat and melt sulfur. At the same time, the electrically heated insulation layer 16 at the bottom of the first sulfur recovery structure 1A is set at 130° C. for insulation. After about 4 hours, the fifth block valve K5 is opened to allow the liquid sulfur to flow into the liquid sulfur storage tank 2. At this time, the fourth pressure gauge P4 is 5.1 Kpa, and the fifth pressure gauge P5 is 35.5 Kpa; when the P5 pressure drops to 5.1 Kpa, it means that all the liquid sulfur in the first sulfur recovery structure 1A flows into the liquid sulfur storage tank 2, and the fifth block valve K5 is closed. The steam heating of the three-stage heat exchanger of the first sulfur recovery structure 1A is turned off, and then the first block valve K1 and the fourth block valve K4 are closed, and the second block valve K2 and the third block valve K3 are opened, and the back-blowing machine is started for purging. When T4 drops to 60° C., the purging is completed. The first sulfur recovery structure 1A processes the state of sulfur to be collected. The liquid sulfur storage tank 2 is set at a constant temperature of 135° C. When the liquid sulfur level inside exceeds the height of the inverted U-shaped pipe, the liquid sulfur will automatically flow into the water-cooled sulfur-solidifying unit 3 through the liquid sulfur nozzle 31 (aperture 2.5 mm). The spherical sulfur particles with a diameter of about 2-3 mm are directly obtained after being rapidly cooled by cold water.

### Example 2

1t/h of 20° C. cooling water is introduced into the heat exchanger of the second sulfur recovery structure 1B, the gate valve 122 is opened, the gate valve 121 is closed, and 2000 Nm³/h, 150° C. gas containing unsaturated sulfur vapor is introduced. After the high-temperature gas is cooled by heat exchange, the temperature drops rapidly: the second thermometer T2 is between 100° C. and 110° C.; the third thermometer T3 is between 48° C. and 57° C.; the fourth thermometer T4 is between 22° C. and 25° C.; after the gas is stably introduced for 75 hours, when the first pressure gauge P1 in the second sulfur recovery structure 1B reaches 10.5 Kpa, the gate valve 121 is slowly opened, the gate valve 122 is closed at the same time, and the first sulfur recovery structure 1A is switched for collection; the sulfur content in the gas after desulfurization treatment is less than 2 ppm.

The second sulfur recovery structure 1B is subjected to heat treatment to melt sulfur: the cooling water in the second sulfur recovery structure 1B is turned off, and 150° C. water vapor is introduced to heat and melt sulfur. At the same time, the electrically heated insulation layer 16 at the bottom of the first sulfur recovery structure 1A is set at 130° C. for insulation. After about 5 hours, the sixth block valve K6 is opened to allow the liquid sulfur to flow into the liquid sulfur storage tank 2. At this time, the fourth pressure gauge P4 is 5.5 Kpa, and the fifth pressure gauge P5 is 35.5 Kpa; when the P5 pressure drops to 5.5 Kpa, it means that all the liquid sulfur in the second sulfur recovery structure 1B flows into the liquid sulfur storage tank 2, and the sixth block valve K6 is closed. The steam heating of the three-stage heat exchanger of the second sulfur recovery structure 1B is turned off, and then the second block valve K2 and the third block valve K3 are closed, and the first block valve K1 and the fourth block valve K4 are opened, and the back-blowing machine is started for purging. When T4 drops to 50° C., the purging is completed. The second sulfur recovery structure 1B processes the state of sulfur to be collected. The liquid sulfur storage tank 2 is set at a constant temperature of 135° C. When the liquid sulfur level inside exceeds the height of the inverted U-shaped pipe, the liquid sulfur will automatically flow into the water-cooled sulfur-solidifying unit 3 through the liquid sulfur nozzle 31 (aperture 2.5 mm). The spherical sulfur particles with a diameter of about 2-3 mm are directly obtained after being rapidly cooled by cold water.

### Example 3

1t/h of 10° C. cooling water is introduced into the heat exchanger of the first sulfur recovery structure 1A, the gate valve 121 is opened, the gate valve 122 is closed, and 1500 Nm³/h, 200° C. gas containing unsaturated sulfur vapor is introduced. After the high-temperature gas is cooled by heat exchange, the temperature drops rapidly: the second thermometer T2 is between 120° C. and 130° C.; the third thermometer T3 is between 60° C. and 70° C.; the fourth thermometer T4 is between 20° C. and 25° C.; after the gas is stably introduced for 52 hours, when the first pressure gauge P1 in the first sulfur recovery structure 1A reaches 10.5 Kpa, the gate valve 122 is slowly opened, the gate valve 121 is closed at the same time, and the second sulfur recovery structure 1B is switched for collection; the sulfur content in the gas after desulfurization treatment is less than 1 ppm.

The first sulfur recovery structure 1A is subjected to heat treatment to melt sulfur: the cooling water in the first sulfur recovery structure 1A is turned off, and 150° C. water vapor is introduced to heat and melt sulfur. At the same time, the electrically heated insulation layer 16 at the bottom of the first sulfur recovery structure 1A is set at 130° C. for insulation. After about 4.5 hours, the fifth block valve K5 is opened to allow the liquid sulfur to flow into the liquid sulfur storage tank 2. At this time, the fourth pressure gauge P4 is 5.0 Kpa, and the fifth pressure gauge P5 is 35.6 Kpa; when the P5 pressure drops to 5.0 Kpa, it means that all the liquid sulfur in the first sulfur recovery structure 1A flows into the liquid sulfur storage tank 2, and the fifth block valve K5 is closed. The steam heating of the three-stage heat exchanger of the first sulfur recovery structure 1A is turned off, and then the first block valve K1 and the fourth block valve K4 are closed, and the second block valve K2 and the third block valve K3 are opened, and the back-blowing machine is started for purging. When T4 drops to 55° C., the purging is completed. The first sulfur recovery structure 1A processes the state of sulfur to be collected. The liquid sulfur storage tank 2 is set at a constant temperature of 135° C. When the liquid sulfur level inside exceeds the height of the inverted U-shaped pipe, the liquid sulfur will automatically flow into the water-cooled sulfur-solidifying unit 3 through the liquid sulfur nozzle 31 (aperture 3 mm). The spherical sulfur particles with a diameter of about 3-4 mm are directly obtained after being rapidly cooled by cold water.

Obviously, the above embodiments are merely examples for clear illustration and are not intended to limit the implementation. For those skilled in the art, other variations or modifications can be made based on the above description. It is neither necessary nor possible to exhaustively list all possible implementation methods here. However, any obvious variations or modifications derived therefrom are still within the scope of protection of the present invention.

1. An apparatus for recovering sulfur from unsaturated sulfur vapor, wherein the apparatus comprises at least two sulfur recovery units (1) arranged in parallel and can be used alternately, a liquid sulfur storage tank (2) and a water-cooled sulfur-solidifying unit (3) arranged below the sulfur recovery units (1), wherein the top of each sulfur recovery unit (1) is connected and then converged upwards to form a sulfur-containing gas inlet (11), the bottom of each sulfur recovery unit (1) is constricted and then extended laterally to form a sulfur-free gas outlet (12), and a gate valve is provided at each sulfur-free gas outlet (12), the sulfur recovery unit (1) is internally provided with a heat exchange structure for condensing sulfur vapor through dry rapid cooling treatment; a liquid sulfur outlet (13) is provided on the bottom pipe wall of each sulfur recovery unit (1), and each liquid sulfur outlet (13) is connected to the liquid sulfur storage tank (2) for storing liquefied sulfur; the water-cooled sulfur-solidifying unit (3) is connected to the bottom of the liquid sulfur storage tank (2), and a liquid sulfur nozzle (31) is provided on the pipeline connected to the liquid sulfur storage tank (2) at the top of the water-cooled sulfur-solidifying unit (3), for rapid cooling and solidifying liquid sulfur into spherical sulfur particles;
wherein the sulfur recovery unit (1) comprises two identical structures, namely a first sulfur recovery unit (1A) and a second sulfur recovery unit (1B), which are alternately used as a cold and a hot unit for cooling and heating each other, each sulfur recovery unit (1) is provided with a three-stage heat exchanger (14) and three guide plates (15), and the three guide plates (15) divide the sulfur recovery unit (1) into four chambers from top to bottom, and each chamber is provided with a pressure gauge and a thermometer.

2-12. (canceled)

13. The apparatus according to claim 1, wherein the three-stage heat exchanger (14) comprises a first-stage heat exchanger (141), a second-stage heat exchanger (142) and a third-stage heat exchanger (143) from bottom to top, and cooling water or steam enters from the first-stage heat exchanger (141) and passes through the second-stage heat exchanger (142) and the third-stage heat exchanger (143) in sequence, thereby achieving the dual effects of cooling and heating.

14. The apparatus according to claim 1, wherein each sulfur recovery unit (1) is provided with an electrically heated insulation layer (16) at a bottom of each sulfur recovery unit (1), and a back-blowing microporous filter (17) is installed at each sulfur-free gas outlet (12);
the sulfur recovery unit (1) is provided with a blower back-blowing device (4) at an outlet of the sulfur recovery unit (1) for purging sulfur-free gas after sulfur melting is completed, thereby achieving the cooling of the sulfur recovery unit (1) and sulfur vapor purging.

15. The apparatus according to claim 1, wherein the liquid sulfur nozzle (31) is located below the liquid sulfur storage tank (2) and is connected by an inverted U-shaped pipe, and the liquid sulfur is sprayed out by using the siphon principle to generate pressure; a linkage trigger switch (32) is provided above the liquid sulfur nozzle (31) and is linked to an agitator (33) at the bottom of the water-cooled sulfur-solidifying unit (3), and the agitator (33) is automatically turned on when liquid sulfur passes through; a constant temperature heating layer (21) is provided on the outside of the liquid sulfur storage tank (2) and on the outside of the pipe connecting the liquid sulfur storage tank (2) to the liquid sulfur nozzle (31), and a pressure gauge is installed inside and above the liquid sulfur storage tank (2) to monitor the flow of sulfur to the liquid sulfur storage tank (2).

16. The apparatus according to claim 15, wherein the top of the inverted U-shaped pipe is lower than the top of the liquid sulfur storage tank (2) and has a height difference of 1.5 to 2.5 meters with the bottom of the liquid sulfur storage tank (2);
the temperature of the constant temperature heating layer (21) is controlled at 130° C. to 135° C. to ensure that the sulfur in the pipeline is a liquid with good fluidity.

17. The apparatus according to claim 1, wherein the inner side of the water-cooled sulfur-solidifying unit (3) is equipped with a water temperature thermometer (34), the upper side is equipped with a water inlet (35) for replenishing chilled water, and the lower side is equipped with a water outlet (36).

18. A method of using the apparatus for recovering sulfur from unsaturated sulfur vapor according to claim 1, wherein the method comprises the following steps:
S1, opening a first gate valve (121) and closing a second gate valve (122), so that the high-temperature gas containing unsaturated sulfur vapor is introduced into a three-stage heat exchanger (14) in a first sulfur recovery unit (1A) through a sulfur gas inlet (11) for dry rapid cooling treatment, so that the sulfur vapor in the gas is condensed in the first sulfur recovery unit (1A), and the sulfur-free gas is discharged from the sulfur-free gas outlet (12) on the first sulfur recovery unit (1A);
S2, when the amount of solid sulfur collected in the first sulfur recovery unit (1A) reaches a set amount, closing the first gate valve (121) and opening the second gate valve (122), switching to the second sulfur recovery unit (1B) for collection; the first sulfur recovery unit (1A) performing heat treatment to melt the sulfur, and collecting the liquid sulfur into the liquid sulfur storage tank (2);
S3, when the liquid sulfur level in the liquid sulfur storage tank (2) reaches a set height, the liquid sulfur automatically flowing into a water-cooled sulfur-solidifying unit (3) through a liquid sulfur nozzle (31), and after rapid cooling treatment by cold water, directly obtaining spherical sulfur particles with a certain size.

19. The method of using an apparatus for recovering sulfur from unsaturated sulfur vapor according to claim 18, wherein the temperature of the high-temperature gas containing unsaturated sulfur vapor in step S1 is in a range from 150° C. to 250° C.

20. The method of using an apparatus for recovering sulfur from unsaturated sulfur vapor according to claim 18, wherein in the three-stage heat exchanger (14) in step S1, cooling water or steam enters a second-stage heat exchanger (142) from a first-stage heat exchanger (141) and finally comes out from a third-stage heat exchanger (143), thereby achieving the dual effects of cooling and heating; when the heat exchanger is used as a cooling device, cold water is introduced; when the heat exchanger is used as a heater, high-temperature steam is introduced.

21. The method of using an apparatus for recovering sulfur from unsaturated sulfur vapor according to claim 18, wherein the first sulfur recovery unit (1A) is activated in step S2 when heat-treated molten sulfur is used as molten sulfur, and the insulation temperature is in a range from 130° C. to 135° C.

22. The method of using an apparatus for recovering sulfur from unsaturated sulfur vapor according to claim 18, wherein in step S3, when the pressure of the fifth pressure gauge (P5) in the liquid sulfur storage tank (2) is greater than the pressure value of the fourth pressure gauge (P4) in the first sulfur recovery unit (1A), it indicates that liquid sulfur in the first sulfur recovery unit (1A) flows into the liquid sulfur storage tank (2); when the pressure of the fifth pressure gauge (P5) is equal to the pressure value of the fourth pressure gauge (P4), it indicates that no liquid sulfur flows into the liquid sulfur storage tank (2).
